(19) United States
(12) Patent Application Publication
(10) Pub. No.: US 2008/0008802 A1
(43) Pub. Date: Jan. 10, 2008

(54) Squeezable colander

(76) Inventor: Laura M. Annunziata, Bronx, NY (US)

Correspondence Address: SUNG I. OH, PROFESSIONAL LAW CORPORATION, 710 QUAIL VALLEY LANE, WEST COVINA, CA, 91791, US

(21) Appl. No.: 11/481,977

(22) Filed: Jul. 6, 2006

(51) Int. Cl. A23L 2/02

(52) U.S. Cl. 426/489

(57) ABSTRACT

A colander is made of flexible material, such as rubber, so it can be squeezed into a form that has a pouring lip and which will permit dispensing the food from the colander into another container via the lip. The colander can also be squeezed to squeeze liquid from food items that are being drained in the colander. The colander can include a stainless steel base.

### TECHNICAL FIELD OF THE INVENTION

The present invention relates to the general art of food preparation, and to the particular field of strainers used in food preparation.

### BACKGROUND OF THE INVENTION

For thousands of years, since before the age of the Roman Empire, man has used various implements for the separation of solid substances from fluids in which they may be suspended, or to separate solids of one size from solids having a different size. Such separation implements which separate mixtures of materials having differences in physical size or being in different physical states, i.e., solid versus liquid phase, are known by various terms including, but not necessarily limited to, sieves, strainers, colanders and the like. Therefore, it is well known to use colanders or strainers for such purposes as rinsing contaminants from fruit, vegetables and the like, and for draining water and other liquids from pastas and other foods after cooking.

Generally speaking, the structure of most straining devices comprises a container or bowl portion into which the mixture or slurry of materials to be strained or separated is poured and at least briefly contained. Usually, the bottom, and sometimes the sides, of the container portion has a plurality of openings. The openings are sized to permit either the passage of that material which one desires to collect or to retain that material which one seeks to keep.

Optional components of a strainer which would be used in food preparation are a handle by which the user holds the strainer and legs on which the strainer may be rested while the materials to be strained are poured from a primary holding container into the strainer itself. Known handles include a straight member extending horizontally from an upper edge or rim of the strainer or its container portion. Another known version of a strainer is shaped much like a coffee mug having on or more handles, each of which is D-shaped and projects horizontally in an outward direction (rather than vertically and in a downward direction) from the upper edge or rim of the strainer or its container portion.

The addition of one or more handles or legs to the basic structure developed out of the need to be able to strain hot mixtures. The handles allow a user to hold the strainer with his hands at a safe distance from the container portion while pouring in the hot mixture. However, a strainer having a single handle suffers from the disadvantage that a single, lone user has only one hand available for lifting the container holding the hot mixture since the other hand must control the strainer itself. Additionally, the wrist of the hand holding the strainer is subjected to a great strain due to the torque when the mixture is initially placed in the strainer.

The addition of legs to a strainer allows the user to place the strainer on an even surface, thus freeing both hands for lifting the container having the hot mixture. However, this structure suffers from the disadvantage that it requires the user to place the strainer onto a surface which will drain away the liquid (where straining edibles and comestibles). Most commonly, the only suitable surface for draining away water from a strainer placed thereon in most households is the kitchen sink. However, when a cook is preparing a meal, the kitchen sink can become the most valuable of all the real estate in a kitchen and it can actually be a hardship to devote all or nearly all of the sink to a strainer. Additionally, it may occur that the bottom of the kitchen sink is already occupied by other items such as dirty dishes, vegetable peels, etc. These must be removed prior to resting a strainer on the sink bottom, thereby requiring additional time and energy when these are in short supply and it may be most inconvenient. Failure to remove such objects leads to the possibility that the strainer will tip over, spilling its contents. Moreover, the contents of the strainer will come into contact with unhygienic or unsavory materials, such as food scrapings, dirty soap water, and the like and may become contaminated thereby.

In one type of colander, an element such as a hanger can extend upwardly from the colander or strainer for attachment to or looping over a water spigot. However, if the colander is suspended from a spigot, the means for suspension of the colander over the sink from the water spigot can slide off of or into the wrong position on the spigot, so as to interfere with easy placement of items into the colander. When suspended from the water spigot the colanders may also make it difficult to use the spigot. Yet another important shortcoming of known colander is difficulty in stowage and placement in dishwashers and the like.

Still further, any device that is used in the kitchen should be easy to use and easy to clean. Furthermore, the device should not be susceptible to contamination finding its way into small openings, such as might be located near hinges and the like.

It should particularly be noted that the basic design of the strainer has not substantially changed from a structural standpoint in thousands of years and that the known strainers and colanders of today's manufacture still suffer from the above disadvantages as did their ancestors many centuries ago. Although advanced modern materials have been developed for manufacturing the modern strainer and colander, i.e., most notably the plastics polyethylene, polypropylene and copolymers, the structure has remained relatively unchanged.

Therefore, there is a need for a colander that improves the design of presently known colanders and overcomes the difficulties just discussed which are associated with presently-available colanders.

### SUMMARY OF THE INVENTION

The above-discussed disadvantages of the prior art are overcome by a colander that is made of flexible material, such as rubber, so it can be squeezed into a form that has a pouring lip and which will permit dispensing the food from the colander into another container via the lip. The colander can also be squeezed to squeeze liquid from food items that are being drained in the colander. The colander can include a stainless steel base.

Using the embodying the present invention will permit other systems, methods, features, and advantages of the invention will be, or will become, apparent to one with skill in the art upon examination of the following figures and detailed description. It is intended that all such additional systems, methods, features, and advantages be included within this description, be within the scope of the invention, and be protected by the following claims.

### BRIEF DESCRIPTION OF THE DRAWING FIGURES

The invention can be better understood with reference to the following drawings and description. The components in the figures are not necessarily to scale, emphasis instead being placed upon illustrating the principles of the invention. Moreover, in the figures, like referenced numerals designate corresponding parts throughout the different views.

FIG. 1 is a perspective view of a first form of a squeezable colander embodying the present invention.

FIG. 2 is a perspective view of a second form of a squeezable colander embodying the present invention.

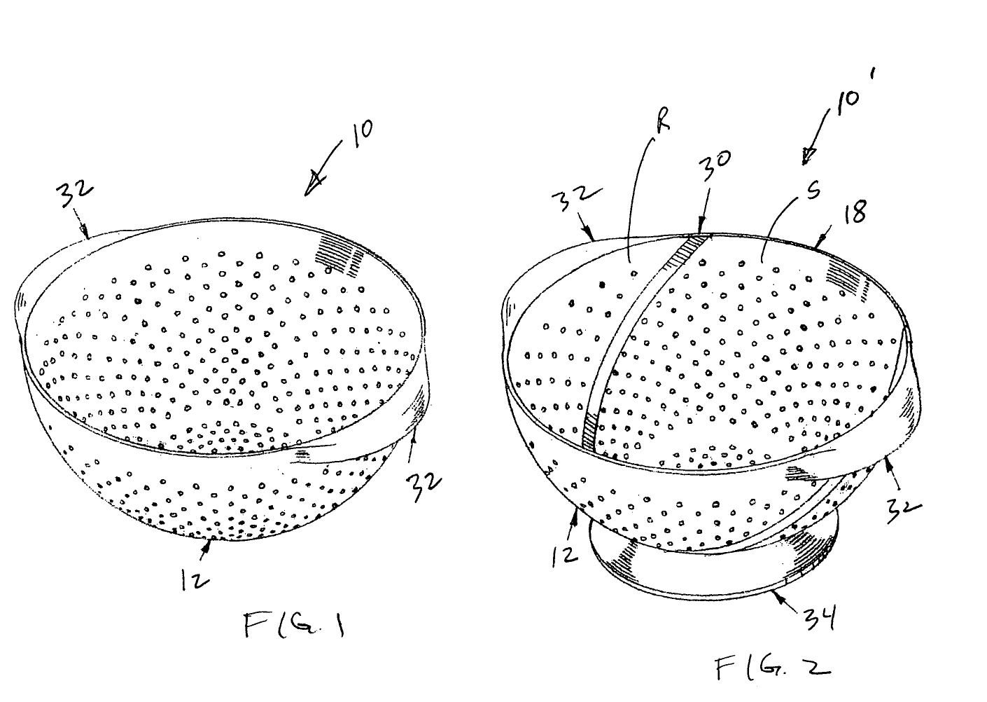

### DETAILED DESCRIPTION OF THE INVENTION

Referring to the figures, it can be understood that the present invention is embodied in a squeezable colander 10. Colander 10 includes a convex base 12 which has an inner surface 14, an outer surface 16, a top rim 18 and a plurality of holes, such as hole 20, defined therethrough. Base 12 is formed of heat resistant rubber to be flexible and squeezable.

The colander can include a band 30 that separates a rubber portion R of the colander from a steel portion S as shown for colander 10′. Colander 10′ can also include hand grips 32, as well as stainless steel stand 34. The colander can be formed in a variety of attractive colors as well as with decorative indicia thereon.

Food is drained by placing the food in the colander and squeezing the body of the colander until liquid is squeezed out of the food. The bendable nature of the colander also allows it to be flexed into a condition that will allow easy and precise pouring of the food from the colander into another container.

While various embodiments of the invention have been described, it will be apparent to those of ordinary skill in the art that many more embodiments and implementations are possible within the scope of this invention. Accordingly, the invention is not to be restricted except in light of the attached claims and their equivalents.

What is claimed is:

1. A squeezable colander comprising:
A) a convex base having an inner surface, an outer surface, a top rim and a plurality of holes defined therethrough;
B) the base being rubber to be flexible and squeezable.

2. The colander defined in claim 1 wherein the rubber is heat resistant.

3. The colander defined in claim 2 further including a stainless steel band dividing a first portion of the colander from a second portion of the colander.

4. The colander defined in claim 3 further including a stainless steel stand on the base.

5. The colander defined in claim 3 further including hand grips on the base.

6. The colander defined in claim 3 wherein the first portion is rubber and the second portion is steel.

7. A method of straining food comprising:
B) forming a colander of rubber;
C) placing food in the colander;
D) squeezing the colander into a form that defines a pouring lip; and
E) dispensing the food from the colander via the pouring lip.

8. The method defined in claim 6 further including a step of squeezing liquid from the food by squeezing the colander.
